(19) United States
(12) Patent Application Publication
(10) Pub. No.: US 2023/0188307 A1
(43) Pub. Date: Jun. 15, 2023

(54) TRIGGERING AND REPORTING MECHANISM FOR SCS CHANGE

(71) Applicant: Telefonaktiebolaget LM Ericsson (publ), Stockholm (SE)

(72) Inventors: Min Wang, Luleå (SE); Jan Christoffersson, Luleå (SE); Mårten Ericson, Gammelstad (SE); Majid Gerami, Lund (SE); Bikramjit Singh, Kirkkonummi (FI); Stefan Wänstedt, Luleå (SE)

(21) Appl. No.: 17/924,499

(22) PCT Filed: May 14, 2021
(86) PCT No.: PCT/IB2021/054164

§ 371 Date: Nov. 10, 2022

Related U.S. Application Data
(60) Provisional application No. 63/024,805, filed on May 14, 2020.

(51) Int. Cl. H04L 5/00; H04W 72/54

(52) U.S. Cl. CPC H04L 5/0094; H04W 72/54

(57) ABSTRACT

Systems and methods for triggering and reporting a Subcarrier Spacing (SCS) change in a wireless communication system are disclosed. In one embodiment, a method performed by a wireless communication device for wireless communication device triggered subcarrier spacing (SCS) change comprises monitoring a status of one or more SCSs at the wireless communication device and sending a SCS change request to a network node based on the monitored status. In this manner, a fast SCS switch triggered by wireless communication device can be achieved.

### RELATED APPLICATIONS

This application claims the benefit of provisional patent application Ser. No. 63/024,805, filed May 14, 2020, the disclosure of which is hereby incorporated herein by reference in its entirety.

### TECHNICAL FIELD

The present disclosure relates to a cellular communications system and, more specifically, to Subcarrier Spacing (SCS) change.

### BACKGROUND

### NR Frame Structure

Different Subcarrier Spacing (SCS) values are supported in Third Generation Partnership Project (3GPP) New Radio (NR). The supported subcarrier spacing values (also referred to as different numerologies) are given by Δf=(15×2\hat{ }μ) kilohertz (kHz) where μ ∈ (0,1,2,3,4). Δf=15 kHz is the basic (or reference) subcarrier spacing that is also used in LTE.

### NR SCS Change

In the NR frequency range, the random access procedure in NR must be improved to mitigate the potential propagation losses at high frequency carriers.

For NR, there is an ongoing discussion in the 3GPP standardization on the use of Band Width Parts (BWPs). The reasons for using BWPs are that some UEs might not be able to use the entire bandwidth, in which case they are assigned a smaller BWP which they are capable of handling and use of this smaller BWP can help reduce power consumption. A UE may be assigned a narrower BWP to reduce the needed energy for reception and transmission. Yet another reason could be for load balancing when the UEs do not need the entire bandwidth to meet the bit rate requirements.

Another discussion that has evolved in the Release 17 work is the impact of different SCSs. For Release 17, new wider SCSs are discussed, namely 960 kHz, 1820 kHz, and 3840 kHz. It is known that, with higher SCS, the radio channel conditions often deteriorate, implying that the UE coverage will be affected negatively, compared to low SCSs. Therefore, the benefits of increased bitrates offered by high SCS may not always be available.

The SCS is configured by Radio Resource Control (RRC) and can be the same or different for uplink and downlink. Also, within the same carrier, the SCS may be different between different BWPs. Also, on different carriers, the SCS can be different. For BWPs, it can be envisioned that different BWPs will be configured with different SCSs. For example, a low SCS on the initial BWP and higher SCSs on other BWPs to enable higher bit rates when coverage is sufficient.

It has been agreed that each UE is assigned with at least an initial BWP, which is the same for all UEs and is narrow enough for all UEs to handle, and a default BWP. The default BWP may be the same as the initial BWP but may also be different (i.e., different UEs will typically have different default BWPs). In addition to the initial BWP and the default BWP, the UE can be configured with additional BWPs. It has been agreed that a UE can have up to four downlink/uplink BWPs. Another important agreement is that, at any point in time, only one BWP is active for a specific UE.

The UE is configured with BWPs using RRC signaling, except the initial which is part of system information (SI), and switching between BWPs is done by DCI on the PDCCH where a Bandwidth part indicator field can indicate a different BWP than the active BWP. There is also a possibility to switch to the default BWP when the bwp-InactivityTimer expires or when Random Access is initiated.

Since the SCS will impact the coverage, it can sometimes be beneficial to change SCS. As described above, this will imply that either the BWP or the carrier is changed (or reconfigured).

### NR BWP Switch Delay

The requirements of BWP switch delay are specified in the 3GPP Technical Specification (TS) 38.133 clause 8.6 (see, e.g., V16.3.0).

### BWP Switch Operation

BWP Switch operation is described in the 3GPP TS 38.321 clause 5.15 (see, e.g., V16.0.0).

### SUMMARY

Systems and methods for triggering and reporting a Subcarrier Spacing (SCS) change in a wireless communication system are disclosed. In one embodiment, a method performed by a wireless communication device for wireless communication device triggered subcarrier spacing (SCS) change comprises monitoring a status of one or more SCSs at the wireless communication device and sending a SCS change request to a network node based on the monitored status. In this manner, a fast SCS switch triggered by wireless communication device can be achieved.

Corresponding embodiments of a wireless communication device are also disclosed. In one embodiment, a wireless communication device for wireless communication device triggered SCS change is adapted to monitor a status of one or more SCSs at the wireless communication device and send a SCS change request to a network node based on the monitored status.

In one embodiment, a wireless communication device for wireless communication device triggered SCS change comprises one or more transmitters, one or more receivers, and processing circuitry associated with the one or more transmitters and the one or more receivers. The processing circuitry is configured to cause the wireless communication device to monitor a status of one or more SCSs at the wireless communication device and send a SCS change request to a network node based on the monitored status.

Embodiments of a method performed by a base station are also disclosed. In one embodiment, a method performed by a base station comprises receiving a SCS change request from a wireless communication device and processing the SCS change request.

Corresponding embodiments of a base station are also disclosed. In one embodiment, a base station is adapted to receive a SCS change request from a wireless communication device and process the SCS change request.

In one embodiment, a base station comprises processing circuitry configured to cause the base station to receive a SCS change request from a wireless communication device and process the SCS change request.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the basic New Radio (NR) physical resource over an antenna port, which can be seen as a time-frequency grid;

FIG. 2 illustrates one example of a cellular communications system in which embodiments of the present disclosure may be implemented;

FIG. 3 illustrates the operation of a base station (e.g., a gNB) and a wireless communication device (e.g., a UE) to enable wireless communication device triggered Subcarrier Spacing (SCS) change requests in accordance with at least some aspects of the embodiments of the present disclosures;

FIGS. 4, 5, and 6 are schematic block diagrams of example embodiments of a radio access node such as, e.g., a base station; and

FIGS. 7 and 8 are schematic block diagrams of example embodiments of a wireless communication device such as, e.g., a UE.

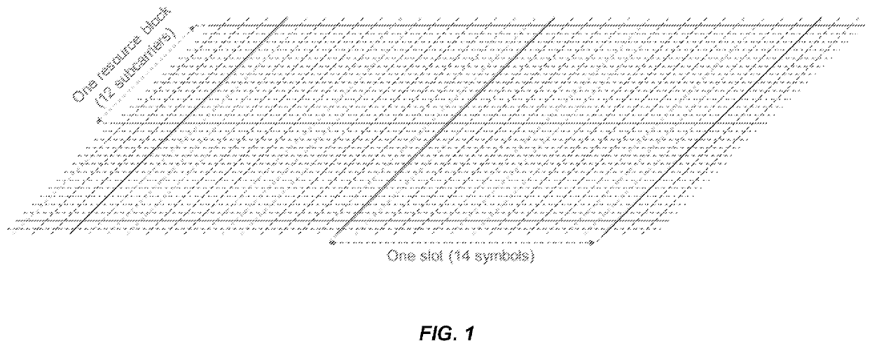

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network

(RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). 3GPP RAN is currently working a study item for NR Release 17 on supporting NR operation from 52.6 Gigahertz (GHz) to 71 GHz (see RP-193259, “3GPP Work Item Description: Study on supporting NR from 52.6 GHz to 71 GHz”, Intel Corporation, 3GPP TSG RAN Meeting #86, Dec. 9-12, 2019.). The succeeding work item will be started immediately after this study item. In this study item and the corresponding work item (WI) phase, it is assumed that the same waveform as in NR Release 15 will be applied, and an even higher Subcarrier Spacing (SCS) value range (between 480 kilohertz (kHz), 960 kHz, 1920 kHz, and 3840 kHz) is being discussed. The slot duration can be scaled in the below table accordingly if assuming 4096 Fast Fourier Transform (FFT) will be applied.

TABLE 1
Numerologies being studied for NR operation from 52.6 GHz to 71 GHz

| | | | | | | |
|---|---|---|---|---|---|---|
| SCS [kHz] | 120 | 240 | 480 | 960 | 1920 | 3840 |
| 275 PRBs allocation [GHz) | 0.40 | 0.79 | 1.58 | 3.17 | 6.34 | 12.67 |
| System BW | 0.44 | 0.88 | 1.76 | 3.52 | 7.04 | 14.08 |

It is known that a lower SCS allows a longer cyclic prefix (CP) and larger coverage. Vice versa, a higher SCS gives a shorter CP and worse coverage. Therefore, a higher SCS together with wider system bandwidth, which is able to provide higher data rate, is only feasible for UEs with good coverage.

Since the available SCSs in Release 17 differ significantly between the lowest SCS and the highest SCS, the actual applied SCS may need to change from time to time depending on the coverage and bit-rate needs. In the current NR releases (up to NR Release 16), SCS change is typically coupled to a Bandwidth Part (BWP) switch. In a wide carrier, multiple BWPs can be configured, each BWP can be configured with the following three different parameters:

SCS,

symbol duration, and

CP length.

As described in the Background section, BWP switching is controlled by the Physical Downlink Control Channel (PDCCH) indicating a downlink assignment or an uplink grant, by the bwp-InactivityTimer, by RRC signaling, or by the Medium Access Control (MAC) entity itself upon initiation of Random Access procedure or upon detection of consistent Listen Before Talk (LBT) failure on Special Cell (SpCell). The below issues are observed:
Issue 1: Based on these mechanisms, the control is mainly left to the gNB. Therefore, a timely BWP switch for a UE would require the gNB to have timely information on UE status. However, there are many cases where a UE may not be able to report its status to the gNB in time.
Issue 2: The current gNB central BWP switch mechanism may cause extra switch latency. It is not beneficial in cases in which a fast SCS switch is required.

Changing BWP or carrier which is configured with one or more BWP(s) when the active BWP or carrier has such high SCS that the coverage is not sufficient to enable high bit rates is advantageous. Also changing to a BWP or carrier with higher SCS when this BWP or carrier has sufficient coverage will be advantageous. A problem in this case is how the network can know if a UE has sufficient coverage on its non-active BWPs. Therefore, it is necessary to study the above issues and develop corresponding enhancements regarding UE triggered SCS switch.

Certain aspects of the present disclosure and their embodiments may provide solutions to the aforementioned or other challenges. For a UE supporting NR operating at higher frequency bands such as in, e.g., Frequency Range 2 (FR2) frequency region or in the region from 52.6 GHz to 71 GHz, or at an even higher frequency region, the UE is configured to be able to perform SCS specific measurements. In one embodiment, the UE is configured to be able to perform SCS specific measurements in terms of measurement quantities such as, e.g., Reference Signal Received Power (RSRP), Reference Signal Received Quality (RSRQ), Signal to Interference plus Noise Ratio (SINR), Received Signal Strength Indicator (RSSI), channel occupancy, and/or LBT/Clear Channel Assessment (CCA) failure statistics (such as, e.g., failure counter, or failure ratio), etc. Based on the measurement results, a SCS change request is triggered by the UE and sent to the gNB. For example, an SCS switch may be triggered by the UE due to at least one of below reasons:
1) current serving SCS cannot provide sufficient coverage,
2) current serving SCS cannot meet Quality of Service (QoS) requirements of a specific service,
3) current serving SCS cannot provide sufficient bandwidth, and/or
4) current serving SCS cannot provide sufficient power saving.

A SCS change may mean, for example:
1) a BWP switch,
2) a BWP segment/channel/subband change, and/or
3) a cell or carrier switch.

Certain embodiments may provide one or more of the following technical advantage(s). Embodiments of the present disclosure achieve a fast SCS switch triggered by UE. Embodiments of the present disclosure provide a mechanism to allow a UE to report its preferred SCS in case the base station (e.g., gNB) assigned SCS is not suitable to the UE in terms of, e.g., coverage, QoS requirement fulfillment, and/or battery saving.

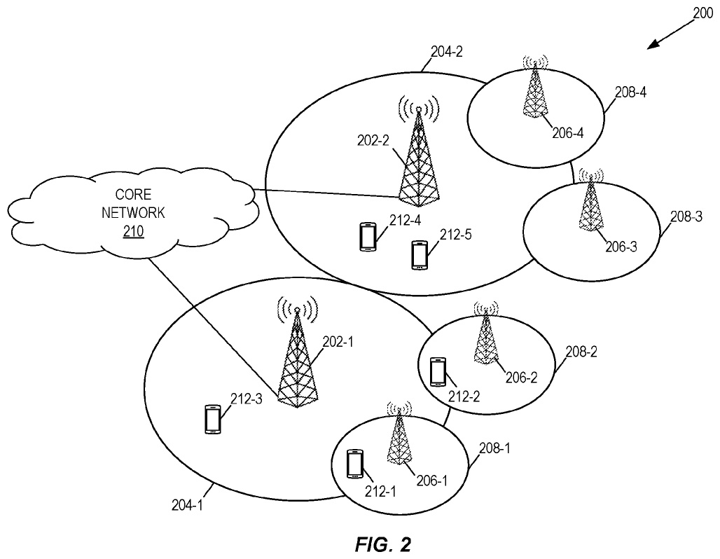

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC); however, the embodiments disclosed herein are also applicable to other types of cellular communications system and other types of wireless systems. In this example, the RAN includes base stations 202-1 and 202-2, which in the 5GS include NR base stations (gNBs) and optionally next generation eNBs (ng-eNBs), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs and as such as also referred to herein as UEs 212 or simply UEs, but the present disclosure is not limited thereto.

Now a description of proposed embodiments of the solution described herein is provided. The proposed embodiments are applicable to both licensed and unlicensed operations.

In a first example, a UE 212 is configured to periodically monitor its status associated with each applied SCS (i.e., an active SCS which is being used by the UE 212 for control or data transmission. In an example, it is the SCS associated with an active BWP, which is one of the BWPs configured to the UE 212) in terms of measurement quantities such as, e.g., RSRP, RSRQ, SINR, RSSI, channel occupancy, and/or LBT/CCA failure statistics (such as failure counter, or failure ratio), etc. Based on the measurement results, a SCS change request is triggered by the UE 212 and sent to the base station 202, which for this description is a gNB. Measurement gaps may be configured for the UE 212 to perform SCS specific measurements. In this case, the UE 212 applies a measurement gap when measuring a SCS which is not being used for the UE 212 to perform transmission or reception.

In case the measurement results indicate that the UE 212 needs to change (or desires to change) the SCS, the UE 212 autonomously selects a suitable configured SCS and applies that selected SCS.

For example, the SCS change request may be sent using the old SCS or using a different SCS (e.g., the new SCS selected autonomously by the UE 212).

the UE 212 may apply at least one of the below options to send the SCS change request.

Option 1: The UE 212 initiates a Random Access Channel (RACH) procedure.

A 4-step RA can be triggered to indicate the SCS change request.

In an example, Msg1 (i.e., the random access preamble) is used to identify the request. A dedicated preamble or dedicated RACH occasions may be allocated to the UE 212 for indicating the SCS change request. The allocation may be pre-defined, determined based on a pre-defined rule, or configured by another node.

In another example, Msg3 is extended to identify the request. In Msg3, the UE MAC entity adds an indicator indicating the SCS change request. The indicator may be, for example, a field in the MAC subheader or carried in a MAC Control Element (CE).

A 2-step RA can be triggered to indicate the SCS change request. A dedicated preamble or dedicated RACH occasions or dedicated PUSCH occasions/resources may be allocated to the UE 212 for indicating the SCS change request. Alternatively, indicators indicating the request can be included in the MsgA payload. The indicator may be a field in the MAC subheader or carried in a MAC CE.

Alternatively, an RRC message (partly or fully) may be included in a RACH message, which includes an indicator(s) of the SCS change request.

Option 2: The UE 212 initiates a Physical Uplink Control Channel (PUCCH) transmission for indicting the SCS change request. In one embodiment, for indicating the SCS change request, separate dedicated PUCCH resources may be configured accordingly.

Option 3: The UE 212 initiates a Physical Uplink Shared Channel (PUSCH) based transmission, such as a configured grant-based transmission, for indicting the SCS change request. In one embodiment, for indicating the SCS change request, separate dedicated configured grant resources may be configured accordingly. Alternatively, an indicator(s) for indicating the SCS change request may be included in the Configured Grant Uplink Control Information (CG-UCI).

Option 4: The UE 212 initiates a Sounding Reference Signal (SRS) transmission for indicting the SCS change request. In one embodiment, for indicating the SCS change request, separate dedicated SRS resources may be configured accordingly.

Specifically, as an additional example to Option 2 and Option 3, the UE 212 can indicate an SCS change request in the PUCCH Uplink Control Information (PUCCH-UCI), which can be carried in the PUCCH or multiplexed with PUSCH.

In the entailing embodiment/example, the Uplink Control Information (UCI) containing SCS change request can have a priority defined in the form of, e.g.,
a. Physical Layer (PHY) priority, or
b. Implicit priority which can be
   a. Higher or lower than Scheduling Request (SR),
   b. Higher or lower than Hybrid Automatic Repeat Request Acknowledgement (HARQ-ACK), or
   c. Higher or lower than Channel State Information (CSI).

In one example, for the resources used for the SCS change request, the resources are configured via higher layer signaling (e.g., RRC signaling). In another example, the resources are signaled using a MAC CE or a DCI.

Furthermore, the SCS change request can be a message that includes information that indicates at least one of the below:
1) SCS change reason(s) (e.g., coverage limitation by the current SCS, current SCS cannot serve the current data volume, current SCS cannot serve the current battery consumption requirement, etc.)
2) information indicating one or more candidate SCSs that are preferred by the UE 212, such as
   Indices of SCSs or SCS groups,
3) the index or information on the SCS(s) that have detected the issues (i.e., index or information on the old SCS(s) for which the problem(s) have been detected or index or information on the SCS(s) that are not acceptable to the UE 212),
4) one or more radio quality related parameters such as, e.g.,
   RSRP measurement(s),
   RSRQ measurement(s),
   SINR measurement(s),
   RSSI measurement(s),
   channel occupancy measurement(s),
   LBT/CCA failure statistics (such as failure counter, or failure ratio) etc.), and/or
   measurement results of other SCSs/BWPs, so that the gNB can select a candidate SCS for the UE based on the measurement results.
      The above information may be transmitted using a single or multiple request messages.

In addition, any of below additional information may be also reported in one or more request/report messages (reported for a measurement object, a carrier, for a group of carriers, for a certain Public Land Mobile Network (PLMN), for a cell, per Physical Cell Identity (PCI), per BWP, per beam/SSB, etc.):
Channel occupancy, e.g., based on RSSI.
LBT statistics e.g., number of LBT failures and/or successes, LBT failure/success ratio (e.g., calculated over a certain time period or using exponential averaging of successive time periods), LBT failure rate (e.g., calculated over a certain time period or using exponential averaging of successive time periods), LBT modes (i.e., Load Based Equipment (LBE) or Frame Based Equipment (FBE)) and LBT types (i.e., Category 1, 2, 3, or 4) with which the UE has detected LBT failures. Either of these could be reported per LBT type or per Channel Access Priority Class (CAPC), or per Uplink (UL)/Downlink (DL), or per service/Logical Channel (LCH)/Logical Channel Group (LCG).
Radio quality indicators, such as RSRP, RSRQ, RSSI, SNR, SINR, etc.
Service QoS indicators such as latency, packet loss, priority, jitter, etc.
Buffer status report.
Power headroom report.
The indices for cells/BWPs/carriers/channels/sub-bands/PLMNs that suffer from LBT failures or high channel occupancy.

For any of the above report messages, the report message may be sent in the same cell in which failure events or LBT failures are being triggered or in a different serving cell.

For a BWP configured to the UE 212, the BWP may contain multiple bandwidth segments referred to as e.g., channel, sub-band, BWP segment, etc. For each segment, the UE 212 may be configured with the following different parameters:
SCS,
Symbol duration, and/or
CP length.

The base station 102 (i.e., gNB in this example) replies with an acknowledgement upon reception of the request/report message indicating an SCS change request from the UE 212. The acknowledgement may be indicated via at least one of the below signaling mechanisms:
1) a DCI addressed to the Cell Radio Network Temporary Identifier (C-RNTI) associated with the UE 212,
2) a signaling message (e.g., an RRC signaling message), or
3) a MAC CE.

The gNB may also provide further signaling to the UE 212 such as, e.g.:
1) on SCSs that the UE 212 should use for subsequent transmissions or receptions.
   These SCS may be the same or different as the UE autonomously selected;
2) to deactivate or reconfigure the corresponding serving cell/BWP/channel in which UE 212 has detected issues with the old SCSs;
3) to switch to a different BWP from the BWP in which UE 212 has detected issues with the old SCSs;
4) to switch to a different serving cell from the cell in which UE 212 has detected issues with the old SCSs; and/or
5) to switch to a different BWP segment/channel/sub-band from the BWP segment/channel/sub-band in which UE 212 has detected issues with the old SCSs.

For any of the embodiments/examples above, a few possible reasons to trigger SCS switch are highlighted below.

In one example, the SCS change request is triggered by the UE 212 when new data have arrived at the UE 212 with critical QoS requirements and high priority. In another example, the SCS change request is triggered by the UE 212 when the data volume of newly arrived data is above a predefined threshold so that the current SCS may not be able to serve the data fulfilling the required QoS requirements.

In one example, the SCS switch request is triggered by the UE 212 when there is a risk that one or multiple uplink transmissions or downlink receptions cannot be performed due to coverage issue.

In one example, the SCS switch request is triggered by the UE 212 in order to reduce power consumption.

In one example, the SCS switch request is triggered by the UE 212 due to change in Transmission/Reception Point (TRP) triggered by the UE 212 itself in case of transmissions with multi-TRP. In this case, each TRP may be associated with a different SCS.

In one example, for a given component carrier (CC) or cell, the UE 212 can be allowed to configure N BWPs with maximum n active BWPs, such that 1≤n≤N. These active BWPs can be associated with traffic of different reliability or priority. Each BWP is associated with different SCS. The plurality of policies can be defined by, e.g.,
The UE 212 transmits the high priority/reliability traffic in the BWP which maps to high priority/reliability.
The UE 212 transmits the low priority/reliability traffic in the BWP which maps to low priority/reliability.
The UE 212 transmits the low priority/reliability traffic in the BWP which maps to high priority/reliability.

Hence, if the UE 212 has the capacity to have multiple active BWPs, then accordingly a capability can be defined, e.g., the UE 212 can have ‘n’ or more active BWPs, where n can be 1 or more.

In one example, in case the UE 212 is allowed to have multiple active BWPs, the UE 212 with multiple transmissions (HARQ-processes) can follow out-of-order arrangement with the transmissions associated with different BWPs in a CC/cell, e.g., if a DCI associated with HARQ-process#X+1 in BWP#M occurs later in time with respect to a DCI associated with HARQ-process#X+2 in BWP#N, then the HARQ-process#X+1 can be allowed to finish earlier than HARQ-process#X+2 (e.g. the PUSCH or PDSCH can happen earlier relatively or HARQ-ACK transmission can happen earlier relatively).

In one example, a UE capability bit indicating whether the UE 212 supports SCS monitoring and switching can be defined accordingly.

In another example, the UE 212 can be configured to conditionally monitor a BWP with different SCS bandwidth than the one currently used, including the measurement gap for this. When the UE's measurement of its own BWP is below a threshold, the UE 212 starts to measure the configured BWP with a lower SCS. If the UE's measurement of its own BWP is above a threshold, the UE 212 starts to measure the configured BWP with a higherSCS.

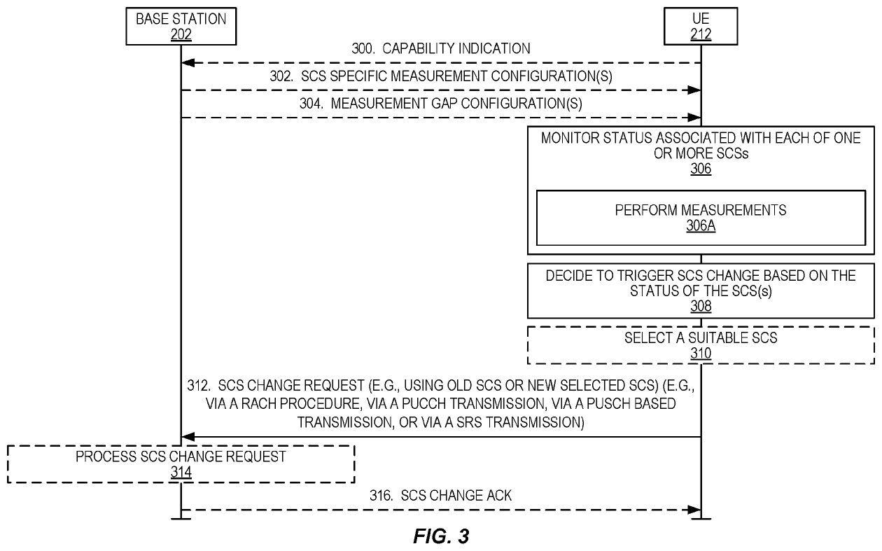

FIG. 3 illustrates the operation of a base station 202 (e.g., a gNB) and a UE 212 in accordance with at least some aspects of the embodiments described above. Note that optional steps are represented by dashed lines/boxes. As illustrated, the UE 212 optionally transmits, to the base station 202, a capability indication that indicates that the UE 212 is capable of UE-initiated SCS change requests (step 300). As described above the base station 212 provides, to the UE 212, one or more SCS specific measurement configurations (step 302) and optionally one or more measurement gap configurations (step 304). The SCS specific measurement configurations are configurations that configure the UE 212 to perform measurements that enable the UE 212 to decide when to trigger a SCS change request. As discussed above, the optional measurement gap configuration(s) configure measurement gaps for the UE 212 to perform SCS specific measurements.

The UE 212 monitors a status of the UE 212 associated with each of one or more SCSs (step 306). For example, the status of the UE 212 associated with a particular SCS may be whether the UE 212 is able to meet one or more requirements using that particular SCS. The one or more SCSs include the current SCS(s) of the UE 212 (i.e., a SCS(s) of a current serving cell(s) of the UE 212) and optionally one or more other SCSs (e.g., SCSs of one or more other BWPs and/or carriers configured for the UE 212 but not active). The status of the UE 212 associated with each SCS may be determined by the UE 212 based on measurements performed by the UE 212 in accordance with the SCS specific measurement configuration(s) of step 302 and optionally the one or more measurement gap configuration(s) of step 304. Note that, in some embodiments, the SCS status monitoring may be performed conditionally. Based on the status(es) of the SCS(s), the UE 212 decides to trigger a SCS change request, as described above (step 308). Note that some example criteria for deciding to trigger the SCS change request have been described.

Optionally, the UE 212 autonomously selects one or more preferred, or candidate, SCSs for the SCS change (step 310). This selection may be based on the measurements performed in step 306.

The UE 212 sends a SCS change request to the base station 202 (step 312). Note that while in the illustrated example, the SCS change request is transmitted to the same base station 202 as that from which the UE 212 receive the measurement configuration(s) in step 302, the present disclosure is not limited thereto. Details of the SCS change request and how the SCS change request is sent are described above. Those details are equally applicable here in regard to step 312.

Optionally, the base station 202 processes the SCS change request (step 314). For example, the SCS change request may include multiple candidate SCSs, and the base station 202 may select one of the indicated candidate SCSs for the SCS change for the UE 212. As another example, the SCS change request does not indicate any candidate SCSs but, instead, includes one or more reports based on which the base station 202 selects a target SCS for the SCS change for the UE 212, as described above. Optionally, the base station 202 sends an acknowledgement to the UE 212 (step 316). Details regarding the acknowledgment are described above and are equally applicable here to step 316.

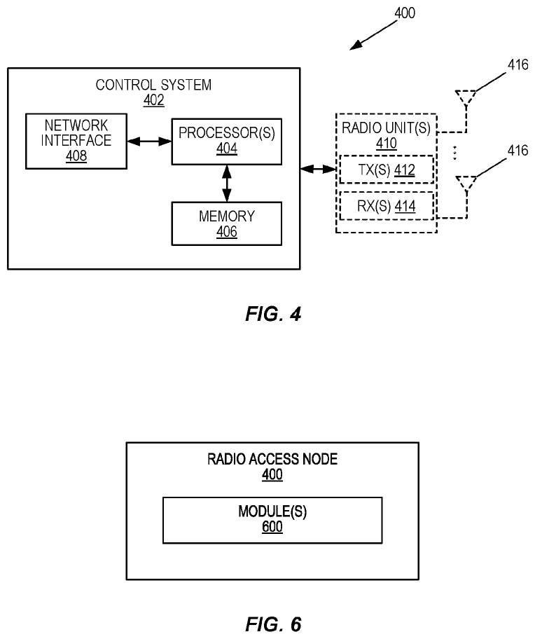

FIG. 4 is a schematic block diagram of a radio access node 400 according to some embodiments of the present disclosure. Optional features are represented by dashed boxes. The radio access node 400 may be, for example, a base station 202 or 206 or a network node that implements all or part of the functionality of the base station 202 or gNB described herein. As illustrated, the radio access node 400 includes a control system 402 that includes one or more processors 404 (e.g., Central Processing Units (CPUs), Application Specific Integrated Circuits (ASICs), Field Programmable Gate Arrays (FPGAs), and/or the like), memory 406, and a network interface 408. The one or more processors 404 are also referred to herein as processing circuitry. In addition, the radio access node 400 may include one or more radio units 410 that each includes one or more transmitters 412 and one or more receivers 414 coupled to one or more antennas 416. The radio units 410 may be referred to or be part of radio interface circuitry. In some embodiments, the radio unit(s) 410 is external to the control system 402 and connected to the control system 402 via, e.g., a wired connection (e.g., an optical cable). However, in some other embodiments, the radio unit(s) 410 and potentially the antenna(s) 416 are integrated together with the control system 402. The one or more processors 404 operate to provide one or more functions of a radio access node 400 as described herein (e.g., functions of the base station 202 or gNB described above with respect to any one or more of the first though tenth embodiments and/or with respect to the process of FIG. 3). In some embodiments, the function(s) are implemented in software that is stored, e.g., in the memory 406 and executed by the one or more processors 404.

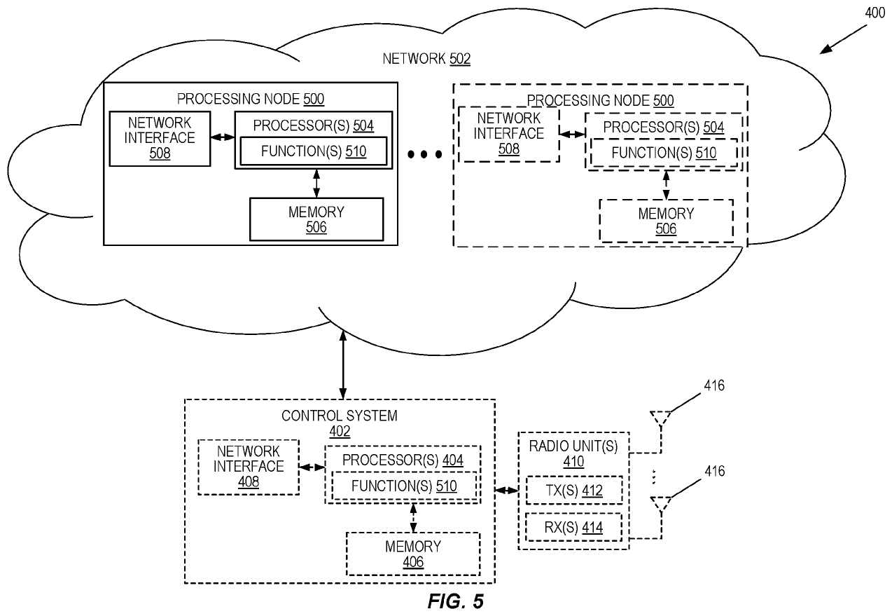

FIG. 5 is a schematic block diagram that illustrates a virtualized embodiment of the radio access node 400 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 400 in which at least a portion of the functionality of the radio access node 400 is implemented as a virtual component(s) (e.g., via a virtual machine(s) executing on a physical processing node(s) in a network(s)). As illustrated, in this example, the radio access node 400 may include the control system 402 and/or the one or more radio units 410, as described above. The control system 402 may be connected to the radio unit(s) 410 via, for example, an optical cable or the like. The radio access node 400 includes one or more processing nodes 500 coupled to or included as part of a network(s) 502. If present, the control system 402 or the radio unit(s) are connected to the processing node(s) 500 via the network 502. Each processing node 500 includes one or more processors 504 (e.g., CPUs, ASICs, FPGAs, and/or the like), memory 506, and a network interface 508.

In this example, functions 510 of the radio access node 400 described herein (e.g., functions of the base station 202 or gNB described above with respect to any one or more of the first though tenth embodiments and/or with respect to the process of FIG. 3) are implemented at the one or more processing nodes 500 or distributed across the one or more processing nodes 500 and the control system 402 and/or the radio unit(s) 410 in any desired manner. In some particular embodiments, some or all of the functions 510 of the radio access node 400 described herein are implemented as virtual components executed by one or more virtual machines implemented in a virtual environment(s) hosted by the processing node(s) 500. As will be appreciated by one of ordinary skill in the art, additional signaling or communication between the processing node(s) 500 and the control system 402 is used in order to carry out at least some of the desired functions 510. Notably, in some embodiments, the control system 402 may not be included, in which case the radio unit(s) 410 communicate directly with the processing node(s) 500 via an appropriate network interface(s).

In some embodiments, a computer program including instructions which, when executed by at least one processor, causes the at least one processor to carry out the functionality of radio access node 400 or a node (e.g., a processing node 500) implementing one or more of the functions 510 of the radio access node 400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 6 is a schematic block diagram of the radio access node 400 according to some other embodiments of the present disclosure. The radio access node 400 includes one or more modules 600, each of which is implemented in software. The module(s) 600 provide the functionality of the radio access node 400 described herein (e.g., functions of the base station 202 or gNB described above with respect to any one or more of the first though tenth embodiments and/or with respect to the process of FIG. 3). This discussion is equally applicable to the processing node 500 of FIG. 5 where the modules 600 may be implemented at one of the processing nodes 500 or distributed across multiple processing nodes 500 and/or distributed across the processing node(s) 500 and the control system 402.

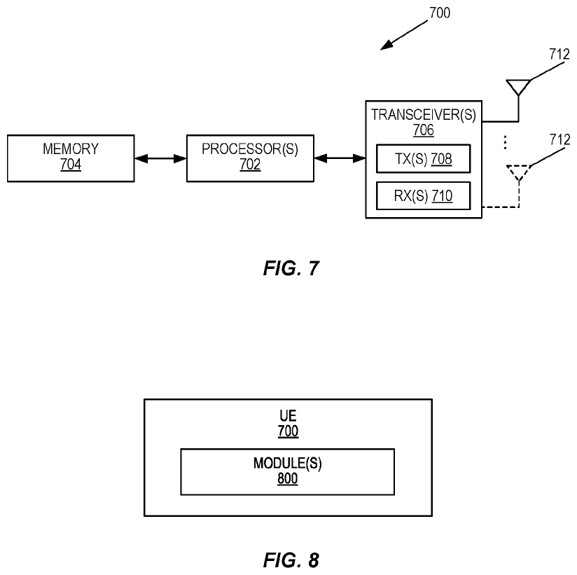

FIG. 7 is a schematic block diagram of a wireless communication device 700 according to some embodiments of the present disclosure. As illustrated, the wireless communication device 700 includes one or more processors 702 (e.g., CPUs, ASICs, FPGAs, and/or the like), memory 704, and one or more transceivers 706 each including one or more transmitters 708 and one or more receivers 710 coupled to one or more antennas 712. The transceiver(s) 706 includes radio-front end circuitry connected to the antenna(s) 712 that is configured to condition signals communicated between the antenna(s) 712 and the processor(s) 702, as will be appreciated by on of ordinary skill in the art. The processors 702 are also referred to herein as processing circuitry. The transceivers 706 are also referred to herein as radio circuitry. In some embodiments, the functionality of the wireless communication device 700 described above (e.g., functions of the UE 212 or UE described above with respect to any one or more of the first though tenth embodiments and/or with respect to the process of FIG. 3) may be fully or partially implemented in software that is, e.g., stored in the memory 704 and executed by the processor(s) 702. Note that the wireless communication device 700 may include additional components not illustrated in FIG. 7 such as, e.g., one or more user interface components (e.g., an input/output interface including a display, buttons, a touch screen, a microphone, a speaker(s), and/or the like and/or any other components for allowing input of information into the wireless communication device 700 and/or allowing output of information from the wireless communication device 700), a power supply (e.g., a battery and associated power circuitry), etc.

In some embodiments, a computer program including instructions which, when executed by at least one processor, causes the at least one processor to carry out the functionality of the wireless communication device 700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the wireless communication device 700 according to some other embodiments of the present disclosure. The wireless communication device 700 includes one or more modules 800, each of which is implemented in software. The module(s) 800 provide the functionality of the wireless communication device 700 described herein (e.g., functions of the UE 212 or UE described above with respect to any one or more of the first though tenth embodiments and/or with respect to the process of FIG. 3).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a wireless communication device for wireless communication device triggered subcarrier spacing, SCS, change, the method comprising:
monitoring a status of one or more SCSs at the wireless communication device; and
sending a SCS change request to a network node based on the monitored status.

2. The method of claim 1 wherein, for each SCS of the one or more SCSs, the status of the SCS is an ability of the wireless communication device to satisfy one or more requirements using the SCS.

3. The method of claim 2 wherein the one or more requirements comprise one or more coverage requirements, one or more Quality of Service, QoS, requirements of a particular service, a bandwidth requirement, a power saving requirement, or any combination thereof.

4. The method of claim 1, wherein monitoring the status of one or more SCSs comprises, for each SCS of the one or more SCSs, performing one or more measurements related to an ability of the wireless communication device to satisfy one or more requirements.

5. The method of claim 4 wherein the one or more requirements comprise one or more coverage requirements, one or more Quality of Service, QoS, requirements of a particular service, a bandwidth requirement, a power saving requirement, or any combination thereof.

6. The method of claim 4 wherein the one or more measurements comprise:
(a) one or more Reference Signal Received Power, RSRP, measurements performed using the SCS;
(b) one or more Reference Signal Received Quality, RSRQ, measurements performed using the SCS;
(c) one or more Signal to Interference plus Noise Ratio, SINR, measurements performed using the SCS;
(d) one or more Received Strength of Signal Indication, RSSI, measurements performed using the SCS;
(e) one or more channel occupancy measurements performed using the SCS;
(f) one or more Listen Before Talk, LBT, or Clear Channel Assessment, CCA, statistics for channel(s) using the SCS; or
(g) a combination of any two or more of (a)-(f).

7. The method of claim 4, further comprising receiving one or more SCS specific measurement configurations for at least some of the one or more measurements.

8. The method of claim 4, further comprising receiving one or more measurement gap configurations that define one or more measurement gaps in which at least some of the one or more measurements are performed.

9. The method of claim 1, further comprising autonomously selecting a SCS for the SCS change request and applying the selected SCS.

10. The method of claim 1, further comprising selecting one or more candidate SCSs.

11. The method of claim 10 wherein the SCS change request comprises information that indicates the one or more candidate SCSs.

12. The method of claim 1, wherein sending the SCS change request comprises sending the SCS change request using a current SCS of the wireless communication device.

13. The method of claim 1, wherein sending the SCS change request comprises sending the SCS change request using a candidate SCS for the SCS change request.

14. The method of claim 1, wherein sending the SCS change request comprises sending the SCS change request via a random access procedure.

15. The method of claim 14 wherein sending the SCS change request via the random access procedure comprises sending the SCS change request by:
transmitting a particular random access preamble,
transmitting a random access preamble in a particular random access resource or occasion,
transmitting a random access preamble from a particular group of random access preambles,
transmitting an indication of the SCS change request in a Msg3 of a 4-step random access procedure, or
transmitting the indication in a payload of a MsgA of a 2-step random access procedure.

16. The method of claim 1, wherein sending the SCS change request comprises sending the SCS change request via a Physical Uplink Control Channel, PUCCH, transmission.

17. The method of claim 1, wherein sending the SCS change request comprises sending the SCS change request via a Physical Uplink Shared Channel, PUSCH, based transmission.

18.-29. (canceled)

30. A wireless communication device for wireless communication device triggered subcarrier spacing, SCS, change, the wireless communication device comprising:
one or more transmitters;
one or more receivers; and
processing circuitry associated with the one or more transmitters and the one or more receivers, the processing circuitry configured to cause the wireless communication device to:
monitor a status of one or more SCSs at the wireless communication device; and
send a SCS change request to a network node based on the monitored status.

31. (canceled)

32. A method performed by a base station, the method comprising:
receiving a subcarrier spacing, SCS, change request from a wireless communication device; and
processing the SCS change request.

33.-40. (canceled)

41. A base station comprising processing circuitry configured to cause the base station to:
receive a subcarrier spacing, SCS, change request from a wireless communication device; and
process the SCS change request.

42. (canceled)
